(19) United States
(12) Patent Application Publication
(10) Pub. No.: US 2025/0303907 A1
(43) Pub. Date: Oct. 2, 2025

(54) CHARGING PORT DISPLAY DEVICE

(71) Applicant: ATSUMITEC CO., LTD., Hamamatsu-shi, Shizuoka (JP)

(72) Inventors: Kojiro GOTO, Hamamatsu-shi (JP); Bumsoo KIM, Hamamatsu-shi (JP)

(21) Appl. No.: 18/864,935

(22) PCT Filed: May 17, 2023
(86) PCT No.: PCT/JP2023/018361

§ 371 Date: Nov. 12, 2024

(30) Foreign Application Priority Data
May 23, 2022 (JP) 2022-083584

(51) Int. Cl. B60L 53/62; B60L 53/16; H02J 7/00

(52) U.S. Cl. CPC B60L 53/62; B60L 53/16; H02J 7/0047

(57) ABSTRACT

A charging port display device includes a display in a power receiver on an outer left wall of a vehicle and to which electric power is supplied from an external power supply, and a charging port display controller to controls the display. The power receiver openably/closably covers, with a lid, a recess portion in which a connector to be connected to a charging plug from the external power supply is installed. The display device includes a lid opening/closing switch to detect opening of the lid. The display includes light emitters at or adjacent to the connector to emit light within the recess portion. The light emitters perform a guidance display mode to guide a line of sight of a worker around the vehicle to the connector by changing a light emission amount of the light emitters, when opening of the lid is detected by the switch.

### BACKGROUND OF THE INVENTION

### 1. Field of the Invention

The present invention relates to display devices included chargers to receive electric power for charging.

### 2. Description of the Related Art

An electric vehicle is provided with a connector (charging port) to which a cable for supplying electric power from the outside is connected in order to charge an in-vehicle rechargeable battery.

Most of a plurality of connectors provided in a vehicle are provided in a recess portion that is recessed inward with respect to an outer wall surface of the vehicle. Further, the vehicle is provided with a lid that openably/closably covers the recess portion.

Further, a vehicle described in Japanese Patent Application Publication No. 2018-43744 is provided with an illumination within a recess portion in such a way as to illuminate the vicinity of a connector, and is configured in such a way as to turn on the illumination when a lid is unlocked.

Further, Japanese Patent Application Publication No. 2018-43744 also discloses a technique in which an LED is used for illumination, and in a case where a rechargeable battery is fully charged during charging, a color and the like of the illumination are changed.

### SUMMARY OF INVENTION

However, simply illuminating the vicinity of a connector at a time of opening a lid as in Japanese Patent Application Publication No. 2018-43744 may make it difficult to instantaneously recognize a position of a connector within the recess portion in all environments such as at nighttime and daytime.

In addition, there is also a demand for a display device that allows a worker near a connector to easily recognize, at a glance and in detail, not only a position of the connector and a full charge state of a rechargeable battery, but also various states and information related to charging.

Example embodiments of the present invention provide charging port display devices that each facilitate easy recognition of a position of a connector at a time of opening a lid that covers the connector, and enables to easily recognize various states and information related to charging.

According to an example embodiment of the present invention, a charging port display device includes a display in a power receiver on an outer wall of a vehicle and to which electric power is supplied from an external power supply, and a display controller configured or programmed to control an operation of the display, wherein the power receiver includes a lid body to openably/closably cover a space in which a connector to which an electric power supply line from the external power supply is connected is installed, the charging port display device includes a lid body opening detector to detect an opening operation of the lid body, the display includes a plurality of light emitters at or adjacent to the connector within the space; and the display includes a light transmission suppressing structure to suppress transmission of light.

Preferably, the display may include the plurality of light emitters arranged in a lateral direction above the connector to irradiate light toward the connector.

Preferably, the display is operable in a guidance display mode in which the plurality of light emitters are sequentially turned on from one of the light emitters closer to the connector to another of the light emitters farther from the connector.

Preferably, the display controller may be configured or programmed to cause all the light emitters to simultaneously blink in the same color as that of the guidance display mode during a connection standby state after the guidance display mode is performed until the electric power supply line is connected to the connector.

Preferably, the display controller may be configured or programmed to cause all the light emitters to simultaneously blink in a color different from that during the guidance display mode and the connection standby state during charging in which the electric power supply line is connected to the connector and electric power is supplied from the external power supply.

Preferably, the display controller may be configured or programmed to cause all the light emitters to turn on in the same color as that during the charging at a time when charging from the external power supply is completed.

Preferably, the display controller may be configured or programmed to cause all the light emitters to simultaneously blink in a color different from that in any display during the guidance display mode, during the connection standby state, during the charging, and at the time of charging completion at a charging disabled time when connection between the connector and the electric power supply line has failed.

Preferably, the display controller may be configured or programmed to cause all the light emitters to simultaneously blink in a color different from that in any display during the guidance display mode, during the connection standby state, during the charging, at the time of charging completion, and at the charging disabled time at a failure time when charging from the external power supply is disabled even when the connector and the electric power supply line are connected to each other.

Preferably, the display may include a plurality of light emitters on an installation plane of the connector located within the space, and arranged in a radial direction around the connector.

Preferably, the display controller may be configured or programmed to repeatedly cause all the light emitters to turn on for a predetermined time by sequentially turning on the plurality of light emitters from one of the light emitters farther from the connector to another of the light emitters closer to the connector, and thereafter, cause all the light emitters to turn off during a connection standby state after the guidance display mode is performed until the electric power supply line is connected to the connector.

Preferably, electric power supplied from the external power supply may be charged in a rechargeable battery in the vehicle, the charging port display device may include a charging rate input to provide a charging rate of the rechargeable battery, and the display controller may be configured or programmed to repeatedly change a color of the light emitters of a number associated with the charging rate among the plurality of light emitters between a color different from that during the guidance display mode and the connection standby state, and the color during the guidance display mode and the connection standby state during charging in which the electric power supply line is connected to the connector and electric power is supplied from the external power supply.

Preferably, the display controller may be configured or programmed to repeatedly cause the plurality of light emitters to sequentially turn on from a light emitter far from the connector to a light emitter close to the connector in a color different from that during the guidance display mode and the connection standby state during charging in which the electric power supply line is connected to the connector and electric power is supplied from the external power supply.

Preferably, the display controller may be configured or programmed to cause all the light emitters to turn on in a color different from that during the guidance display mode and the connection standby state, and in a color of light emitted during the charging at a time when charging from the external power supply is completed.

Preferably, the display may include a light transmission suppressing structure to suppress transmission of light.

According to example embodiments of the present invention, providing a plurality of light emitters at or adjacent to a connector, and performing guiding display to guide a line of sight to the connector by changing a light emission amount of the plurality of light emitters at a time of opening a lid facilitates easy recognition of a position of the connector.

In addition, since a plurality of light emitters are provided, many kinds of display modes can be achieved by optionally causing each light emitter to turn on and off, and blink. Therefore, a worker at or adjacent to the connector can easily recognize an open state of the lid, and various states and information related to charging.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view illustrating a structure of a display and a vicinity of a mounting portion thereof in a charging port display system according to a first example embodiment of the present invention.

FIG. 2 is a vertical cross-sectional view illustrating a structure of the display and the vicinity of the mounting portion thereof in the first example embodiment of the present invention.

FIG. 3 is an explanatory diagram of a detailed structure of the display in the first example embodiment of the present invention.

FIG. 4 is a configuration diagram of the charging port display system according to the first example embodiment of the present invention.

FIG. 5 is a front view illustrating a structure of a display and a vicinity of a mounting portion thereof in a charging port display system according to a second example embodiment of the present invention.

FIG. 6 is an image diagram illustrating a display example of the display in the second example embodiment of the present invention during charging.

### DETAILED DESCRIPTION OF THE EXAMPLE EMBODIMENTS

Hereinafter, example embodiments the present of invention are described in detail with reference to the drawings.

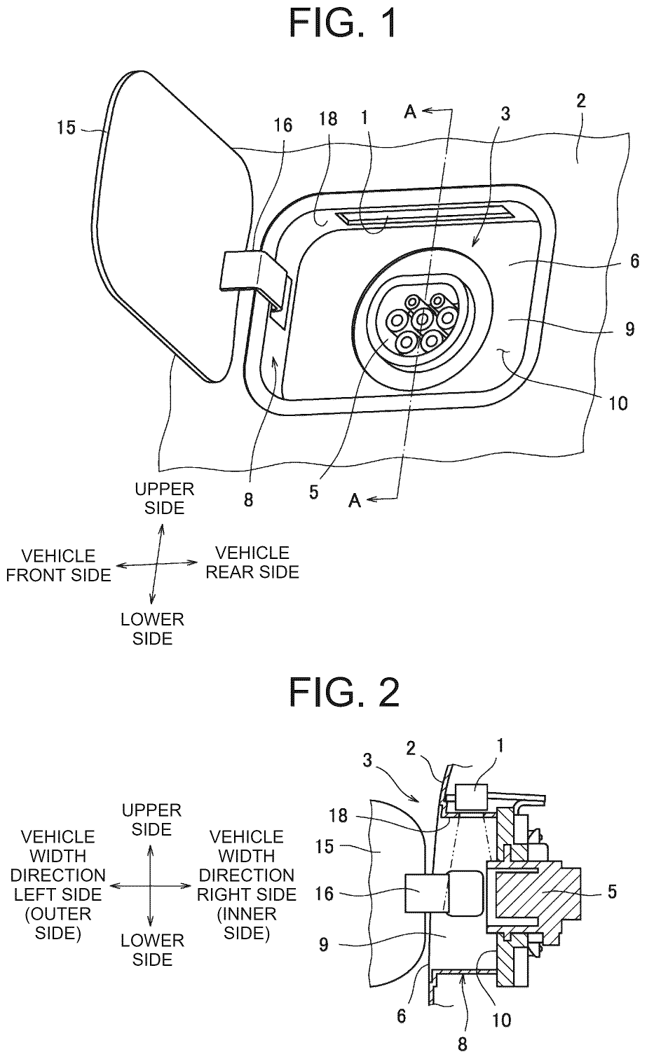

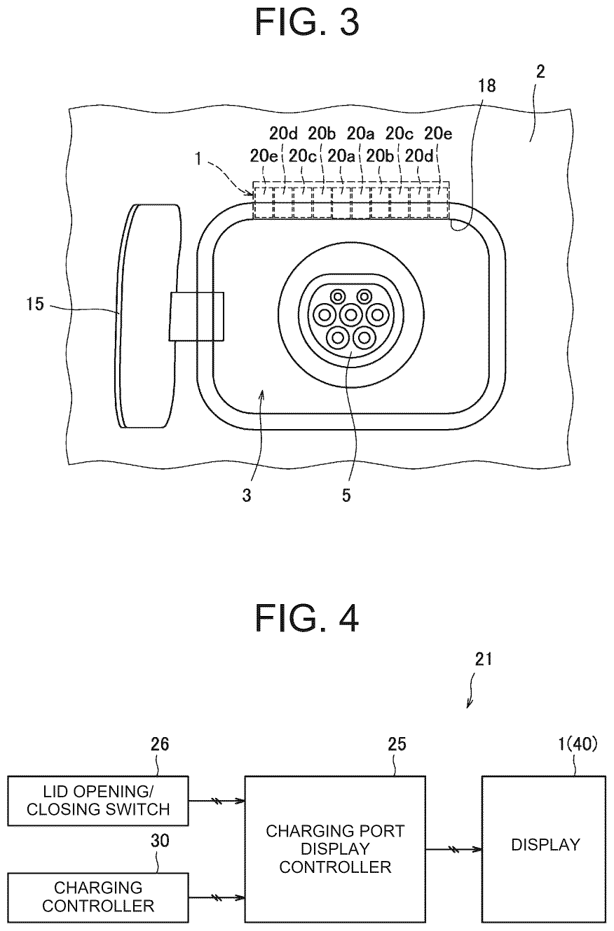

FIG. 1 is a perspective view illustrating a structure of a display 1 and a vicinity of a mounting portion thereof in a charging port display system (charging port display device) according to the first example embodiment of the present invention. FIG. 2 is a vertical cross-sectional view illustrating a structure of the display 1 and the vicinity of the mounting portion thereof in the first example embodiment. Note that, FIG. 2 is a cross-sectional view taken along the portion A-A described in FIG. 1. FIG. 3 is an explanatory diagram of a detailed structure of the display 1 in the first example embodiment, and is a diagram when the display 1 and the vicinity of the mounting portion thereof are viewed from a front side.

As illustrated in FIGS. 1 and 2, the display 1 in a charging port display system 21 according to the first example embodiment of the present invention is provided in a power receiver 3 provided on, for example, an outer left wall 2 (outer wall) of an electric vehicle (hereinafter, referred to as a vehicle).

The power receiver 3 includes a connector 5 to which a charging plug at an end of a charging cable (electric power supply line) is connected. Electric power is supplied from an external power supply via the charging cable (including a charging plug) and the connector, and an unillustrated rechargeable battery loaded in the vehicle is charged.

A rectangular or substantially rectangular opening portion 6 is located in the outer left wall 2 of the vehicle, and a rectangular or substantially rectangular box-shaped housing 8 is provided in such a way as to cover the opening portion 6 of the outer left wall 2 from the inside. Specifically, a recess portion 9, which is a space recessed inward from the outer left wall 2 of the vehicle, is defined by the housing 8.

The connector 5 is fixed to a bottom wall 10, which is a wall surface of the housing 8 on the vehicle inner side (the right side in the vehicle width direction), and is arranged in such a way as to face the outside of the opening portion 6.

The power receiver 3 is provided with a lid 15, which is a lid body that covers the opening portion 6.

The lid 15 has a rectangular or substantially rectangular plate shape slightly larger than the opening portion 6, and a portion of the lid 15 on the vehicle front side is supported on the inside of the outer left wall 2 by a hinge 16.

Therefore, when the lid 15 is closed, the power receiver 3 is brought to a closed state in which the opening portion 6 is covered, and when the lid 15 is opened, the opening portion 6 is opened, and the power receiver 3 is brought to an opened state in which the charging plug can be connected to the connector 5.

As illustrated in FIG. 3, the display 1 in the first example embodiment of the present invention is provided on an upper wall 18 of the housing 8, and includes a plurality of light emitters 20 such as LEDs. The light emitters 20 can be switched and turned on in at least white, blue, yellow, and red individually. Further, as illustrated by a two dot chain line in FIG. 2, the light emitters 20 are positioned in such a way as to irradiate light downward toward the connector 5.

The light emitters 20 are arranged to have the same number on the left and right sides (in the vehicle front-rear direction) with respect to a middle position of the connector 5 in the vehicle front-rear direction as a middle, for example. In the present example embodiment, two sets of five light emitters 20, i.e., ten light emitters 20 in total are provided, for example, and the light emitters 20 are respectively referred to as light emitters 20a, 20b, 20c, 20d, and 20e from the middle side toward both outer sides.

FIG. 4 is a configuration diagram of the charging port display system 21 including the display 1.

As illustrated in FIG. 4, the charging port display system 21 includes the display 1, a charging port display controller 25 (a charging rate input, a display controller), and a lid opening/closing switch 26 (lid body opening detector).

The lid opening/closing switch 26 is provided in the vehicle, and detects opening and closing of the lid 15. Detection information of the lid opening/closing switch 26 is input to the charging port display controller 25. Further, the charging port display controller 25 receives current charging state information (charging rate) of the rechargeable battery of the vehicle from a charging controller 30, which is a control device of the charging system of the vehicle, and also receives an operation state of the charging system of the vehicle. The operation state of the charging system is, for example, information such as an insertion state of the charging plug into the connector 5, a failure of the charging system, and charging completion.

The charging port display controller 25 is configured or programmed to include an input/output device, a storage device (a ROM, a RAM, a nonvolatile RAM, or the like), a central processing unit (CPU), and the like, and is configured or programmed to perform operation control (display control) of the light emitters 20 in the display 1 according to an opening/closing state of the lid 15, an operation state of the charging system, and the like.

Next, display modes of the display 1 in the first example embodiment are described.

The display 1 changes a display mode according to the following various states (1) to (6), for example.

In a case where an opening operation of the lid 15 from a closed state is input from the lid opening/closing switch 26, the charging port display controller 25 controls the display 1 in such a way that a guidance display mode of turning on the light emitters 20 from the middle light emitter 20a and in order of the light emitters 20b, 20c, 20d, and 20e is performed. When the light emitter 20e on the outermost side is turned on, all the light emitters 20a to 20e are turned on. All the light emitters 20a to 20e are turned on in white, and the light emitters 20a to 20e are turned on within, for example, 1.5 seconds. Then, all the light emitters 20a to 20e are kept turned on. In this way, in the display 1, at a time of opening the lid, the guidance display mode is performed in which the light emitters are turned on in such a way that light illuminating the connector 5 spreads from the middle side toward the outer side. Note that, regarding display at a time of opening the lid, in addition to switching to sequentially turn on from an off-state as described above, strong light may be caused to spread from the inner side toward the outer side by sequentially increasing illuminance (output) of the light emitters 20a to 20e.

During a charging standby state after the above-described guidance display mode at a time of opening the lid is performed until the charging plug is inserted into the connector 5, all the light emitters 20a to 20e are caused to blink simultaneously in white, which is the same color as that at a time of opening the lid at intervals of, for example, 0.8 second (repeatedly turning on and off every 0.8 second).

During charging in which the charging plug is inserted into the connector 5, and charging current is being supplied from the external power supply to the rechargeable battery, all the light emitters 20a to 20e are caused to blink simultaneously, for example, in blue, which is a color different from that (1) at a time of opening the lid, and (2) during a standby state at intervals of, for example, 0.8 second.

In a case where charging completion of the rechargeable battery of the vehicle, specifically, a full charged state of the rechargeable battery is input from the charging controller 30, all the light emitters 20a to 20e are turned on in the same color (blue) as that (3) during charging.

In a case where the charging system is in a relatively light charging disabled state such as an insertion failure of the charging plug into the connector 5, all the light emitters 20a to 20e are caused to blink simultaneously in a color that is different from the colors in (1) to (4), and in a color (for example, yellow) that calls attention, at intervals of, for example, 0.5 second.

In a case where the charging system is in a relatively serious charging disabled state such as a charging system failure, all the light emitters 20a to 20e are caused to blink simultaneously in a color different from the colors in (1) to (5), and in a color (for example, red) that calls more attention than (5) at a time of warning at intervals of, for example, 0.5 second.

As described above, in the vehicle provided with the charging port display system 21 according to the first example embodiment, the power receiver 3 to which electric power is supplied from the external power supply is provided on the outer left wall 2 of a vehicle body, and the power receiver 3 is configured in such a way that the recess portion 9 in which the connector 5 to which the charging plug at an end of the charging cable to supply electric power from the external power supply is connected is installed is openably/closably covered by the lid 15.

The display 1 in the charging port display system 21 according to the first example embodiment includes ten light emitters 20 (2 sets of light emitters 20a to 20e) that are at or adjacent to the connector 5 and emit light within the recess portion 9, for example. Then, in a case where an opening operation of the lid 15 is detected by the lid opening/closing switch 26, the display 1 performs a guidance display mode to guide a line of sight to the connector 5 by changing a light emission amount of the plurality of light emitters 20. Therefore, a worker in the vicinity of the vehicle can easily recognize a position of the power receiver 3 and an opening operation of the lid 15.

Since the light emitters 20 of the display 1 in the first example embodiment are arranged in a lateral direction above the connector 5, and disposed in such a way as to irradiate light toward the connector 5, a position of the power receiver 3, in particular, the connector 5 can be easily recognized by light emitted by the light emitters 20.

Further, at a time of opening the lid, the guidance display mode is performed in which the plurality of light emitters 20 are sequentially turned on from the light emitter 20a close to the connector 5 to the light emitter 20e far from the connector 5. Therefore, visibility of a position of the connector 5 can be remarkably improved for a worker who is nearby the vehicle for performing a charging operation. In particular, visibility can be improved both at nighttime and daytime.

Although the guidance display mode is performed once, thereafter, all the light emitters 20 are caused to blink simultaneously in the same color as that in the guidance display mode during a connection standby state until the charging plug is connected to the connector 5. This enables to improve visibility of a position of the connector 5 even in a connection standby state, and allows a worker to recognize that the connector 5 is in a connection standby state. In addition, since the light emitters 20 are disposed in such a way as to emit light toward the connector 5, a position of the connector 5 can be easily recognized, for example, at nighttime, and connection of the charging plug to the connector 5 is made easy.

Further, during charging in which the charging plug is connected to the connector 5 and electric power is supplied from the external power supply, all the light emitters 20 are caused to blink simultaneously in a color different from that during a guidance display mode and a connection standby state. This allows a worker to recognize that charging is being performed. In particular, in the present example embodiment, causing the light emitters 20 to blink in blue allows a worker to intuitively recognize that the charging system is operated normally.

Then, at a time of charging completion, turning on all the light emitters 20 in the same color as that during charging allows a worker to easily recognize that charging has been completed.

Further, at a charging disabled time due to a connection failure of the connector, all the light emitters 20 are caused to blink simultaneously in yellow, which is a color different from that in any display during the guidance display mode, during a connection standby state, during charging, and at a time of charging completion. Therefore, a worker can easily recognize that charging is disabled.

Further, at a failure time of the charging system such that charging from the external power supply is disabled even when the connector 5 and the charging plug are connected to each other, all the light emitters 20 are caused to blink simultaneously in red, which is a color different from that of the guidance display mode, during a connection standby state, during charging, a time of charging completion, and a charging disabled time. Therefore, it is possible to allow a worker to easily recognize that charging is disabled, and recognize that the charging system is in a relatively serious abnormal state.

In the present example embodiment, as described above, the display 1 includes the plurality of light emitters 20 such as LEDs capable of emitting light in a plurality of different colors near the connector 5, and a color and a display mode are switched. Therefore, this allows a worker near the connector 5 to easily recognize various states such as the guidance display mode to the connector 5 at a time of opening the lid, a connection standby state, charging, charging completion, a charging disabled time, and a failure time.

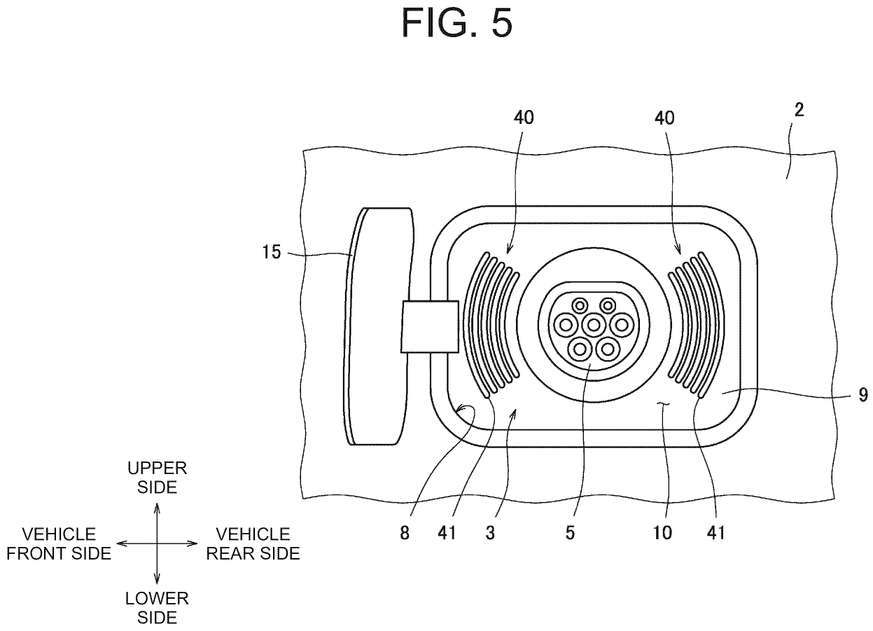

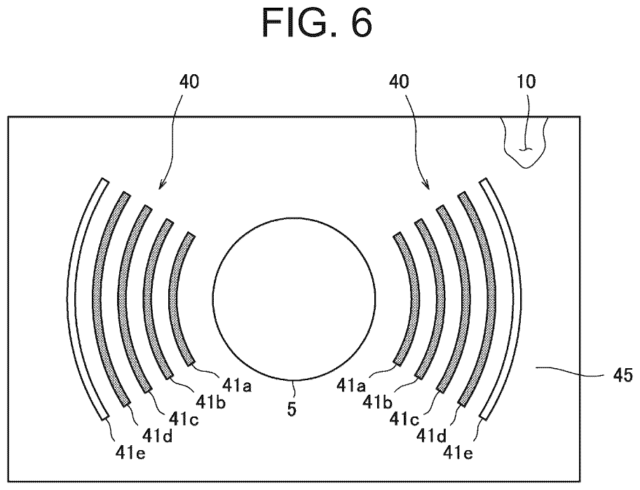

FIG. 5 is a front view illustrating a structure of a display 40 and a vicinity of a mounting portion thereof in a charging port display system according to the second example embodiment of the present invention. FIG. 6 is an image diagram illustrating a display example of the display 40 in the second example embodiment during charging.

A charging port display system 21 according to the second example embodiment of the present invention differs from the charging port display system 21 according to the first example embodiment in a display.

As illustrated in FIGS. 5 and 6, the display 40 in the second example embodiment is provided on a bottom wall 10 (installation plane) of a housing 8 to which a connector 5 is fixed, and includes a plurality of light emitters 41 such as LEDs.

The light emitters 41 in the display 40 have an arc shape with respect to the connector 5 as a center, and are arranged in a radial direction in the same number each on the left and right sides (in the vehicle front-rear direction) of the connector 5. In the present example embodiment, two sets of five light emitters 41 are provided on the left and right sides, and the light emitters are respectively referred to as light emitters 41a, 41b, 41c, 41d, and 41e from the center side toward both outer sides, for example.

In addition, a light transmission suppressing sheet 45 (a light transmission suppressing structure) having a low light transmittance is attached to the bottom wall 10 of the housing 8 in such away as to cover the light emitters 41. This enables to make it difficult to find a turned-on position at a time of turning off the light emitters 41, which increases a difference in appearance with respect to a time of turning off the light emitters 41, when the light emitters 41 are turned on in a bright environment, and makes it easy to recognize that the light emitters 41 are turned on. Therefore, a worker can more easily recognize various states and information related to charging.

Next, display modes of the display 40 in the second example embodiment are described.

A display mode of the display 40 is changed according to the following various states (1) to (5), for example.

As in the first example embodiment, a charging port display controller 25 is configured or programmed to cause the light emitters 41 to sequentially turn on from the middle light emitter 41a and in order of the light emitters 41b, 41c, 41d, and 41e, when an opening operation of a lid 15 from a closed state is input from a lid opening/closing switch 26. When the light emitter 41e on the outermost side is turned on, all the light emitters 41a to 41e are turned on. All the light emitters 41a to 41e are turned on in white, and the light emitters 41a to 41e are turned on within, for example, 1.5 seconds. Then, all the light emitters 41a to 41e are kept turned on. In this way, in the display 40, at a time of opening the lid, the guidance display mode is performed in which the light emitters are turned on in such a way that light spreads from the inner side toward the outer side around the connector 5. Note that, regarding the guidance display mode at a time of opening the lid, as in the first example embodiment, in addition to switching to sequentially turn on from an off-state, strong light may be caused to spread by sequentially increasing illuminance (output) of the light emitters 20a to 20e from the inner side toward the outer side.

During a charging standby state after the above-described guidance display mode at a time of opening the lid is performed until a charging plug is inserted into the connector 5, the light emitters 41a to 41e are turned on one by one in white, which is the same color as that at a time of opening the lid, for example, every 0.3 second from the outer side toward the inner side, all the light emitters 41a to 41e are turned on for 0.5 second, and thereafter, all the light emitters 41a to 41e are turned off for 0.5 second, and this is repeated until the charging plug is inserted.

During charging, the charging port display controller 25 changes a display mode of the display 40 according to a charging state (charging rate) of a rechargeable battery of a vehicle input from a charging controller 30.

Among the plurality of left and right light emitters 41a to 41e, the light emitter 41a on the innermost side has a charging rate of 0% to 20%, the light emitter 41b has a charging rate of 21% to 40%, the light emitter 41c has a charging rate of 41% to 60%, the light emitter 41d has a charging rate of 61% to 80%, and the light emitter 41e on the outermost side has a charging rate of 81% to 100%, for example.

The charging port display controller 25 controls an operation of the light emitter 41 associated with a charging rate during charging in such a way that the color is changed from blue to white and then to blue, for example, every 0.5 second. The light emitter 41 on the inner side of the light emitter 41 associated with the charging rate is kept turned on in blue, and the light emitter 41 on the outer side of the light emitter 41 associated with the charging rate is kept turned on in white.

Note that, as another display example during charging, all the light emitters 41 may be displayed in such a way that, for example, blue light flows from the outside to the inside.

Further, display may be performed in such a way that blue display flows from the outside to the inside by the light emitter 41 associated with the charging rate, and the light emitter 41 on the inner side of the light emitter 41.

In a case where charging completion of the rechargeable battery is input from the charging controller 30, the charging port display controller 25 causes all the light emitters 41a to 41e to turn on in the same color (blue) as that (3) during charging. Note that, charging completion is, for example, a range (for example, a charging rate of 99% to 100%) close to a charging rate of 100%.

In a case where the charging system is in a relatively light charging disabled state such as an insertion failure of the charging plug into the connector 5, as in the first example embodiment, all the light emitters 41a to 41e are caused to blink simultaneously in a color different from the colors in (1) to (4), and in a color (for example, yellow) that calls attention at intervals of, for example, 0.5 second.

In a case where the charging system is in a relatively serious charging disabled state such as a charging system failure, as in the first example embodiment, all the light emitters 41a to 41e are caused to blink simultaneously in a color different from the colors in (1) to (5) and in a color (for example, red) that calls more attention than (5) at a time of warning at intervals of, for example, 0.5 second.

As described above, the display 40 of the charging port display system 21 according to the second example embodiment includes ten light emitters 41 (two sets of light emitters 41a to 41e) which are at or adjacent to the connector 5, and emit light within a recess portion 9 in which the connector 5 is accommodated as in the first example embodiment, and in a case where an opening operation of the lid 15 is detected, the guidance display mode to guide a line of sight to the connector 5 is performed by changing a light emission amount of the plurality of light emitters 41. Therefore, a worker in the vicinity of the vehicle can easily recognize a position of the power receiver 3 and an opening operation of the lid 15.

Since the light emitters 41 of the display 40 in the second example embodiment are a plurality of left and right arc-shaped light emitters 41 (41a to 41e) located on the bottom wall 10, which is a mounting plane of the connector 5, and arranged in a radial direction around the connector 5, a position of the power receiver 3, in particular, the connector 5 can be easily recognized by light emitted by the light emitters 41.

In addition, at a time of opening the lid, the guidance display mode is performed in which the plurality of light emitters 41 are sequentially turned on in such a way that light spreads from the light emitter 41a close to the connector 5 to the light emitter 41e far from the connector 5. Therefore, it is possible for a worker who is nearby the vehicle to perform a charging operation to remarkably improve visibility of a position of the connector 5, in particular, at both of nighttime and daytime.

During a connection standby state after the guidance display mode is performed, sequentially turning on the light emitters 41a and 41e one by one from the light emitter 41a far from the connector 5 to the light emitter 41e close to the connector 5 in the same color as that of the guidance display mode is repeated. This improves the visibility of a position of the connector 5 even in a connection standby state, and allows a worker to recognize that the connector is in a connection standby state.

Further, during charging, the color of the light emitters 41a to 41e of the number associated with a charging rate of the rechargeable battery of the vehicle is changed between blue, which is a color different from that during the guidance display mode and a connection standby state, and white, which is used during the guidance display mode and a connection standby state. This allows a worker to recognize that charging is being performed. In addition, since the number of light emitters that change the color is different in accordance with the charging rate of the rechargeable battery of the vehicle, it also becomes possible for a worker to easily recognize the charging rate. In addition, is operated changing the color between blue and white allows a worker to intuitively recognize that the charging system is operated normally.

Further, at a time of charging completion, turning on all the light emitters 41 in blue, which is used during charging, allows a worker to easily recognize that charging has been completed.

Further, also in the second example embodiment, all the light emitters 41 are caused to blink simultaneously in yellow, which is a color different from that in any display during the guidance display mode, during a connection standby state, during charging, and at a time of charging completion at a charging disabled time due to a connection failure of the connector. Therefore, a worker can easily recognize that charging is disabled.

Further, also in the second example embodiment, at a failure time of the charging system, all the light emitters 41 are caused to blink simultaneously in red, which is a color different from that of the guidance display mode, during a connection standby state, during charging, at a time of charging completion, and at a charging disabled time. Therefore, it is possible to easily recognize that charging is disabled, and allow a worker to recognize that the charging system is in a relatively serious abnormal state.

Description of the example embodiments has been made in the foregoing, however, the present invention is not limited to the above-described example embodiments. For example, the display 1 or 40, and a shape of the light emitter 20 or 41 in the above-described example embodiments may be modified as necessary. For example, the light emitter 41 of the second example embodiment may be circular or shape surrounding the connector 5, a linear shape extending in an up-down direction, or the like. Further, in the first and second example embodiments, a case where the light emitters 20 or 41 are, for example, 5 sets (ten in total) of light emitters has been described. However, the display 1 or 40 may include a large number of light emitters 20 or 41, for example.

Further, in the above-described example embodiments, the display 1 or 40, and the charging port display controller 25 are individual structural elements, however, these may be integrally formed.

Further, in the above-described example embodiments, the lid 15 has a rectangular or substantially rectangular shape, however, the lid 15 may have another shape such as a round or substantially round shape. Further, the space (recess portion 9) within the housing 8 in which the connector 5 is accommodated may have a shape other than a rectangular box shape, such as a round box shape. Example embodiments of the present invention can be widely applied to any structure in which a space to accommodate a charging connector is covered with a lid.

Further, in the above-described example embodiments, a detailed structure of other various components can also be modified appropriately. Further, a display mode may also be modified appropriately within a range that does not deviate from example embodiments of the present invention. For example, the guidance display mode in which light emitters are turned on in such a way that light spreads may be performed twice or more at a time of opening the lid.

Further, in the above-described example embodiments, the display 1 or 40 is provided in the power receiver 3 provided on the outer left wall 2 of the vehicle. However, example embodiments of the present invention can be widely applied to a charger in which the power receiver 3 is provided in a portion other than the outer left wall 2, such as a rear portion or a front portion of the vehicle, or the inside of a vehicle compartment.

While example embodiments of the present invention have been described above, it is to be understood that variations and modifications will be apparent to those skilled in the art without departing from the scope and spirit of the present invention. The scope of the present invention, therefore, is to be determined solely by the following claims.

1-17. (canceled)

18. A charging port display device comprising:
a display in a power receiver on an outer wall of a vehicle and to which electric power is supplied from an external power supply; and
a display controller configured or programmed to control an operation of the display; wherein
the power receiver includes a lid body to openably/closably cover a space in which a connector to which an electric power supply line from the external power supply is connected is installed;
the charging port display device includes a lid body opening detector to detect an opening operation of the lid body;
the display includes a plurality of light emitters at or adjacent to the connector within the space; and
the display includes a light transmission suppressing structure to suppress transmission of light.

19. The charging port display device according to claim 18, wherein the display includes a plurality of the light emitters arranged in a lateral direction above the connector and to irradiate light toward the connector.

20. The charging port display device according to claim 19, wherein the display is operable in a guidance display mode in which a plurality of the light emitters are sequentially turned on from one of the light emitters closer to the connector to another of the light emitters farther from the connector.

21. The charging port display device according to claim 20, wherein the display controller is configured or programmed to cause all the light emitters to simultaneously blink in a same color as that of the guidance display mode during a connection standby state after the guidance display mode is performed until the electric power supply line is connected to the connector.

22. The charging port display device according to claim 21, wherein the display controller is configured or programmed to cause all the light emitters to simultaneously blink in a color different from that during the guidance display mode and the connection standby state, during charging in which the electric power supply line is connected to the connector and electric power is supplied from the external power supply.

23. The charging port display device according to claim 22, wherein the display controller is configured or programmed to cause all the light emitters to turn on in the same color as that during the charging, at a time when charging from the external power supply is completed.

24. The charging port display device according to claim 23, wherein the display controller is configured or programmed to cause all the light emitters to simultaneously blink in a color different from that in any display during the guidance display mode, during the connection standby state, during the charging, and at the time of charging completion, at a charging disabled time when connection between the connector and the electric power supply line has failed.

25. The charging port display device according to claim 24, wherein the display controller configured or programmed to cause all the light emitters to simultaneously blink in a color different from that in any display during the guidance display mode, during the connection standby state, during the charging, at the time of charging completion, and at the charging disabled time, at a failure time when charging from the external power supply is disabled even when the connector and the electric power supply line are connected to each other.

26. The charging port display device according to claim 18, wherein the display includes a plurality of light emitters on an installation plane of the connector located within the space, and arranged in a radial direction around the connector.

27. The charging port display device according to claim 26, wherein the guidance display mode is a display mode in which a plurality of the light emitters are sequentially turned on from one of the light emitters closer to the connector to another of the light emitters farther from the connector.

28. The charging port display device according to claim 27, wherein the display controller is configured or programmed to repeatedly cause all the light emitters to turn on for a predetermined time by sequentially turning on a plurality of light emitters from one of the light emitters farther from the connector to another of the light emitters closer to the connector, and thereafter, causes all the light emitters to turn off, during a connection standby state after the guidance display mode is performed until the electric power supply line is connected to the connector.

29. The charging port display device according to claim 28, wherein
electric power supplied from the external power supply is charged in a rechargeable battery in the vehicle;
the charging port display device includes a charging rate input to provide a charging rate of the rechargeable battery; and
the display controller is configured or programmed to repeatedly change a color of the light emitters of a number associated with the charging rate among a plurality of light emitters between a color different from that during the guidance display mode and the connection standby state, and a color during the guidance display mode and the connection standby state, during charging in which the electric power supply line is connected to the connector and electric power is supplied from the external power supply.

30. The charging port display device according to claim 28, wherein the display controller is configured or programmed to repeatedly cause a plurality of light emitters to sequentially turn on from one of the light emitters farther from the connector to another of the light emitters closer to the connector in a color different from that during the guidance display mode and the connection standby state, during charging in which the electric power supply line is connected to the connector and electric power is supplied from the external power supply.

31. The charging port display device according to claim 29, wherein the display controller is configured or programmed to cause all the light emitters to turn on in a color different from that during the guidance display mode and the connection standby state but same as a color of light emitted during the charging, at a time when charging from the external power supply is completed.

32. The charging port display device according to claim 31, wherein the display controller is configured or programmed to cause all the light emitters to blink in a color different from that in any display during the guidance display mode, during the connection standby state, during the charging, and at the time of charging completion, at a charging disabled time when connection between the connector and the electric power supply line has failed.

33. The charging port display device according to claim 32, wherein the display controller is configured or programmed to cause all the light emitters to simultaneously blink in a color different from that in any display during the guidance display mode, during the connection standby state, during the charging, at the time of charging completion, and at the charging disabled time, at a failure time when charging from the external power supply is disabled even when the connector and the electric power supply line are connected to each other.

34. The charging port display device according to claim 18, wherein the display controller is configured or programmed to control an operation of the display in such a way as to perform a guidance display mode to guide a line of sight to the connector by changing a light emission amount of the plurality of light emitters, when an opening operation of the lid body is detected by the lid body opening detector.

35. The charging port display device according to claim 26, wherein the display controller is configured or programmed to control an operation of the display in such a way as to perform a guidance display mode to guide a line of sight to the connector by changing a light emission amount of the plurality of light emitters, when an opening operation of the lid body is detected by the lid body opening detector.
